(19) United States
(12) Patent Application Publication
(10) Pub. No.: US 2026/0119381 A1
(43) Pub. Date: Apr. 30, 2026

(54) AUTOMATED TEST GENERATION USING MACHINE LEARNING ANALYSIS OF TEST COMPONENTS

(71) Applicant: International Business Machines Corporation, Armonk, NY (US)

(72) Inventors: Arvind HARAN, Liberty Hill, TX (US); Bryan G. HICKERSON, Cedar Park, TX (US); Manoj DUSANAPUDI, Bangalore (IN); Tuhin MAHMUD, Austin, TX (US)

(21) Appl. No.: 18/928,327

(22) Filed: Oct. 28, 2024

(51) Int. Cl. G06F 11/36; G06F 16/383

(52) U.S. Cl. CPC G06F 11/3692; G06F 16/383

(57) ABSTRACT

Method and apparatus for automated test generation are provided. One or more coverage events are received. One or more test components involved in triggering each of one or more coverage events are recorded. The one or more test components are stored in a database, each test component being linked to a corresponding coverage event. A dependency graph is generated, representing relationships between the one or more test components for the one or more coverage events. A correlation between each test component and the corresponding coverage event is determined by performing correlation analysis. A ranking list for each of one or more coverage events is generated, where the ranking list comprises the one or more test components involved in triggering the corresponding coverage event, and the one or more test components are ranked based on the determined correlation.

### BACKGROUND

The present disclosure relates to computer testing, and more specifically, to automatically generating test cases using machine learning (ML) analysis of test components.

### SUMMARY

One embodiment presented in this disclosure provides a method, including receiving one or more coverage events, recording, during simulation, one or more test components involved in triggering each of one or more coverage events, storing the one or more test components in a database, each test component being linked to a corresponding coverage event, generating a dependency graph representing relationships between the one or more test components for the one or more coverage events, determining a correlation between each test component and the corresponding coverage event by performing correlation analysis, and generating a ranking list for each of one or more coverage events, where the ranking list comprises the one or more test components involved in triggering the corresponding coverage event, and the one or more test components are ranked based on the determined correlation.

Other embodiments in this disclosure provide non-transitory computer-readable media containing computer program code that, when executed by operation of a computer system, performs operations in accordance with one or more of the above methods, as well as systems comprising one or more memories collectively containing one or more programs, and one or more processors, wherein the one or more processors are configured to, individually or collectively, perform an operation in accordance with one or more of the above methods.

### BRIEF DESCRIPTION OF THE DRAWINGS

FIG. 1 depicts an example computing environment for the execution of at least some of the computer code involved in performing the inventive methods.

FIG. 2 depicts an example architecture for data collection, according to some embodiments of the present disclosure.

FIG. 3 depicts an example architecture for correlation analysis, according to some embodiments of the present disclosure.

FIG. 4 depicts an example architecture for test case generation, according to some embodiments of the present disclosure.

FIG. 5 depicts an example method for generating dependency graphs and identifying top-ranked test components, according to some embodiments of the present disclosure.

FIG. 6 depicts an example method for generating test cases based on top-ranked features, according to some embodiments of the present disclosure.

FIG. 7 is a flow diagram depicting an example method for data collection and correlation analysis, according to some embodiments of the present disclosure.

FIG. 8 is a flow diagram depicting an example method for automated test generation, according to some embodiments of the present disclosure.

FIG. 9 depicts an example computing device configured to perform various aspects of the present disclosure, according to some embodiments of the present disclosure.

### DETAILED DESCRIPTION

Verification coverage analysis is used to evaluate the effectiveness of test stimuli on design verification. While existing tools can correlate test cases with the coverage events they are likely to trigger, there is limited understanding of the underlying reasons for the correlations. This lack of deeper insight presents several challenges. First, it becomes difficult to optimize the test suite, potentially leading to inefficiencies where some core (or important) events remain untested while other areas are over-tested. Furthermore, the inability to pinpoint the precise factors contributing to the success of certain test cases limits the development of more targeted and efficient testing strategies.

The present disclosure addresses these and other challenges by introducing techniques for automated test generation with a deeper understanding of the correlation between test components and coverage events. In some embodiments of the present disclosure, the system may first collect detailed data from test cases during simulation in a data lake, particularly, focusing on those that successfully trigger coverage events and recording the test components that were executed. Using this data, the system may apply statistical models and/or machine learning algorithms to estimate the correlation between the test components and the corresponding coverage events (e.g., the likelihood that a given component will trigger a specific coverage event). Based on this analysis, the system may rank the test components, placing those most strongly correlated with triggering each coverage event at the top. Additionally, in some embodiments, the system may construct a dependency graph, which maps the relationships between test components and identifies any prerequisites or dependencies between them. The ranking list of test components, combined with the dependency graph, may allow the system to create optimized test sequences that prioritize the test components most likely to trigger coverage events. By leveraging this approach, the system may generate new test cases that are both efficient and targeted, reducing redundancy in testing while maintaining a comprehensive coverage for all relevant design elements or system behaviors.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

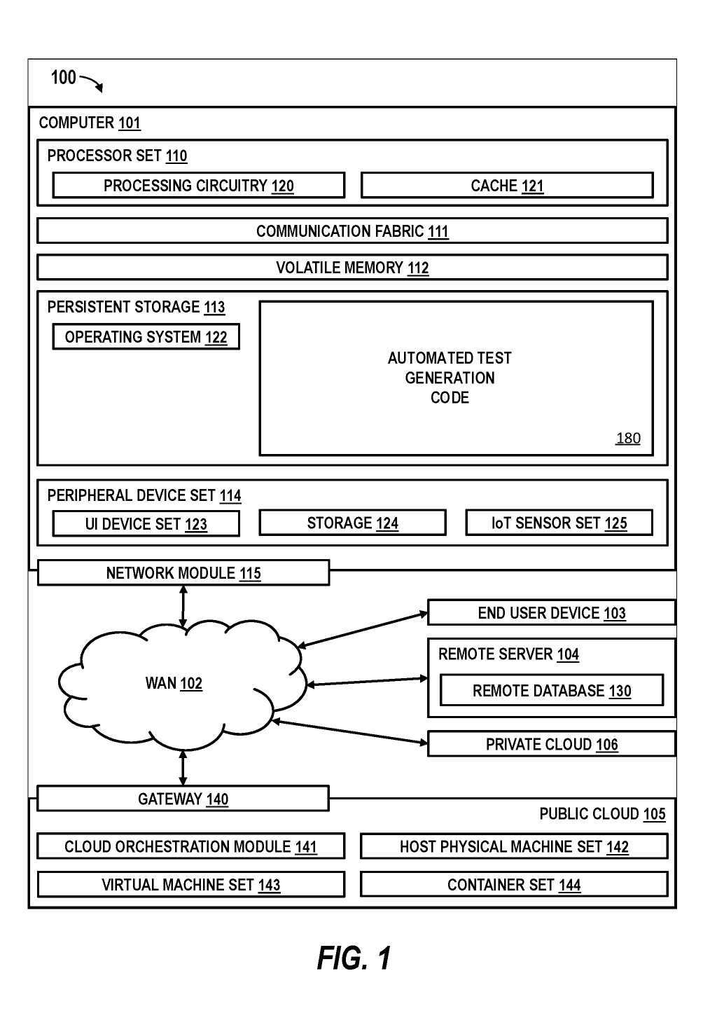

FIG. 1 depicts an example computing environment for the execution of at least some of the computer code involved in performing the inventive methods.

Computing environment 100 contains an example of an environment for the execution of at least some of the computer code involved in performing the inventive methods, such as Automated Test Generation Code 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Automated Test Generation Code 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Automated Test Generation Code 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in Automated Test Generation Code 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private cloud 106 and public cloud 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

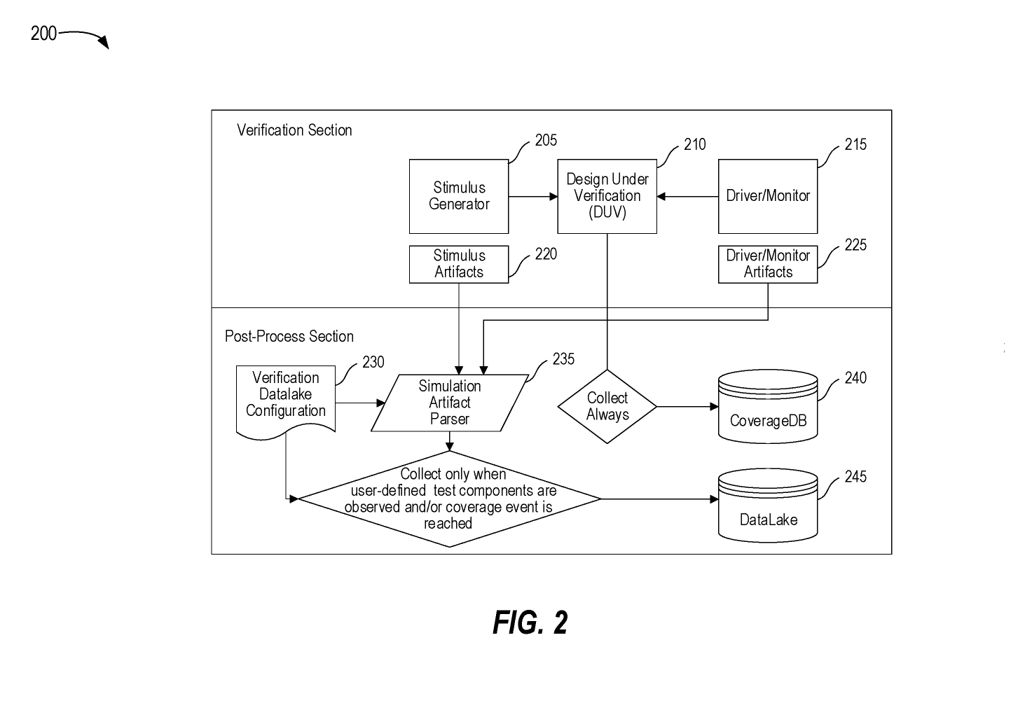

FIG. 2 depicts an example architecture 200 for data collection, according to some embodiments of the present disclosure.

The figure depicts an example architecture 200 for data collection in a simulated verification environment. As depicted, the example architecture 200 includes two sections: the verification section and the post-process section. The verification section includes a stimulus generator 205, a design under verification (DUV) 210, and a driver/monitor 215. The stimulus generator 205 is configured to generate test stimuli for the DUV 210 to exercise different test cases. As used herein, test stimuli refers to the inputs, parameters, instructions, or scenario information that are applied to the DUV 210 to verify a particular function or behavior of the system under various conditions. For example, the test stimuli may include parameters like initial values for registers, memory addresses, and timing information, or specific instructions (or operations) to be executed by the DUV 210. As depicted, the test stimuli are applied to the DUV 210, and information within the test stimuli (e.g., parameters, instructions, or scenarios) is saved as stimulus artifacts 220 for further analysis.

The DUV 210 is the simulated hardware or system being tested. As depicted, the DUV 210 processes the stimuli generated by the stimulus generator 205 and responds based on its internal logic. The DUV’s 210 interactions are monitored by the driver/monitor 215, which collects data on how the system behaves under various test conditions.

As depicted, the driver/monitor 215 observes and tracks the behavior of the DUV 210 in response to the applied stimuli. In some embodiments, the driver/monitor 215 may capture execution data (e.g., the instructions or operations executed by the DUV 210 in response to the stimuli, including macros and individual instructions), state changes (e.g., changes to registers, memory, or flags), coverage results (e.g., related to which coverage events were triggered (or hit) during the test), and/or performance data (e.g., latencies or resource usage). The data collected by driver/monitor 215 are saved as driver/monitor artifacts 225. The driver/monitor artifacts 225 may provide detailed information on the internal responses of the DUV 210 during the test, and may be used for further correlation and effectiveness analysis.

After the stimulus artifacts 220 and driver/monitor artifacts 225 are generated, these artifacts are provided to the simulation artifact parser 235 for analysis. As discussed above, the stimulus artifacts 220 may contain detailed information about the inputs applied to the DUV 210, and the driver/monitor artifacts 225 may record the DUV’s 210 responses, including the execution of instructions, state changes, and whether specific coverage events were triggered.

As used herein, a coverage event refers to a specific system state or behavior that needs to be tested to verify that the DUV 210 functions as expected. During testing, some coverage events are difficult to reach during general testing (e.g., by running randomly generated test cases), potentially because the specific conditions required to trigger these events may not occur frequently or naturally during general testing. To address this challenge, the tester may define one or more test components that are expected to contribute to triggering these coverage events. These test components may include macros, specific instructions, or sets of instructions from a particular category. For example, a hard-to-reach state may include “instruction storage interrupt.” The tester may define three specific instructions expected to increase the likelihood of triggering this state. These instructions may include long-latency floating point instructions (which can cause speculation for younger instructions in the pipeline) (hereinafter referred to as Test Component A), branch instructions (which are typically targeted toward specific memory values, such as branch close, branch far, or branches addressing specific memory locations) (hereinafter referred to as Test Component B), and store instructions (which may overlap with memory regions accessed by the branch instructions, creating multiple translation paths to the same physical memory) (hereinafter referred to as Test Component C). These user-defined test components represent operations believed to be key (or at least important) to reaching the target state.

The simulation artifact parser 235 processes the data by analyzing both the stimulus and driver/monitor artifacts 220 and 225. As illustrated, the simulation artifact parser 235 identifies (i) when any of the user-defined test components (e.g., Test Components A, B, and C) are executed and the coverage event is hit, or (ii) the target coverage event (e.g., the “instruction storage interrupt” event) is reached, even if none of the user-defined components were part of the test. If either condition is met, the simulation artifact parser 235 captures and records all relevant information from the test case(s) that caused the coverage event. This may include details on any additional test components involved (e.g., Test Components D and E). For example, if a test case involving Test Components A, B, or C successfully triggers the “instruction storage interrupt” event, the stimulation artifact parser 235 may capture and save this data. Similarly, if the state is triggered without Test Components A, B, or C, but with Test Components D and E, the test case may also be recorded. All data is stored in a database for further analysis.

As depicted, the simulation artifact parser 235 is guided by verification datalake configuration 230, which provides specific instructions on how and when to save parsed data. When the user-defined instructions are executed or the coverage event is hit, the simulation artifact parser 235, based on the verification datalake configuration 230, may save the data to a database, which is part of the larger datalake architecture 245.

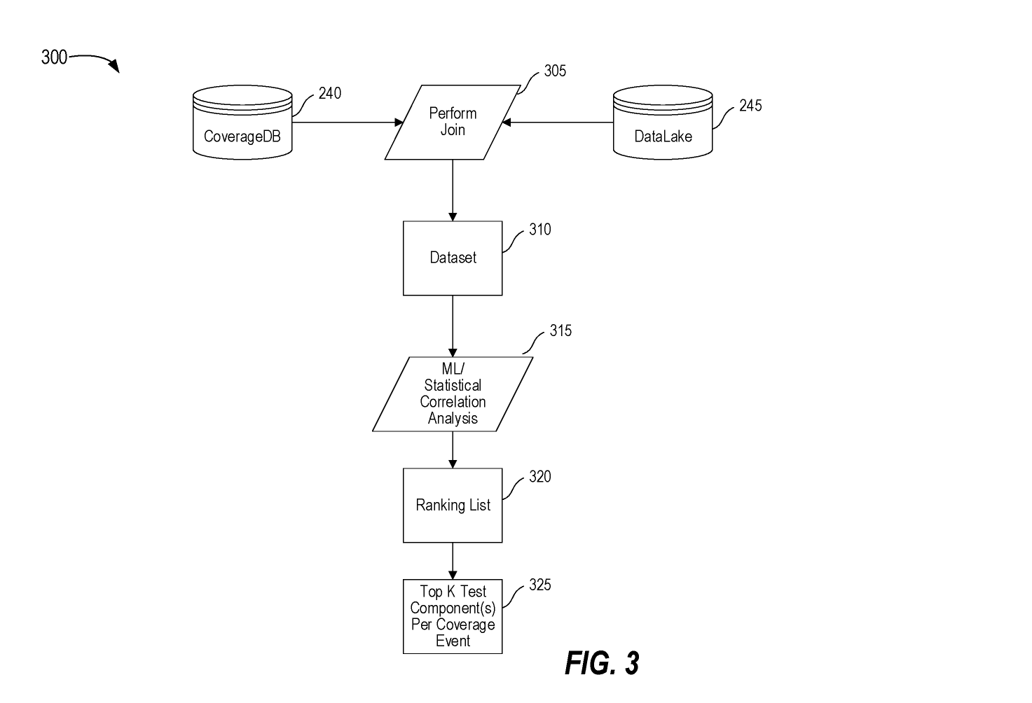

In addition to the parsed data stored in the datalake 245 for further analysis, the coverage database 240 also records coverage results throughout the testing process. The coverage database 240 may track all test cases, including whether the desired coverage event (e.g., “instruction storage interrupt”) was reached or not. In some embodiments, the coverage database 240 may record the test components involved in each test case, such as the instructions or macros that have been executed, even if the target state was not hit. The coverage database 240 may provide an overall view of how often the coverage event was reached and missed. The data collected in the coverage database 240 may then be compared with the information in the datalake 245 (which contains data only from hit cases) to assess the correlation between specific test components and their effectiveness in triggering the desired coverage event. More details for the comparison are discussed below with reference to FIG. 3.

FIG. 3 depicts an example architecture 300 for correlation analysis, according to some embodiments of the present disclosure.

As depicted, the data collected in the coverage database 240 and the datalake 245 (which contains data from hit cases) are joined to create a dataset 310. As discussed above, the coverage database 240 provides the overall test outcomes, including whether the coverage events were hit or missed, while the datalake 245 contains information about the test components (e.g., macros, instructions) involved in each hit case. By joining these two data sources, the dataset 310 is generated. In some embodiments, the dataset 310 may link the specific test components involved (e.g., Test Components A-E) when the coverage event or state (e.g., “instruction storage interrupt” event) was reached to the overall outcomes from the coverage database 240. In some embodiments, in the dataset 310, the test components may be saved as input features, representing the instructions or macros executed during the test, and the coverage outcomes (e.g., hit or miss) may be saved as the output variables or target variables, representing whether the test case successfully triggered the desired state.

As illustrated, correlation analysis is initiated to analyze the generated dataset 310. More specifically, in some embodiments, this correlation analysis process may involve applying either a statistical model or machine learning (ML) model to analyze the correlation between the test components and the coverage outcomes. Through the analysis, the system may identify which test components are most strongly associated with successfully triggering the desired coverage event (or state).

In some embodiments, the statistical model may use a score-based approach to calculate the frequency and correlation of each test component within the hit outcomes. Test components that frequently appear in successful test cases may be assigned higher scores. For example, if Test Component A appears in most of the hit cases (e.g., which triggers the “instruction storage interrupt” state), it would be considered highly important and assigned a high score. Based on the scores, the statistical model may generate a ranking list 320 of the test components for each coverage event (or state), based on their effectiveness in triggering the corresponding coverage event (or state).

In some embodiments, the ML model may be trained using the test components as input features and the coverage outcomes as the target outputs. The model learns to predict the likelihood that the execution of a specific test component will trigger a coverage event. Various algorithms may be selected for training the model, such as decision trees, random forests, support vector machines (SVMs), and neural networks (NNs). In embodiments where NNs are used, the learning process may involve backpropagation, where internal parameters of the model (e.g., weights or bias) may be adjusted to minimize the difference between the predicted outputs (whether the event will be triggered) and the actual output (whether the event was triggered) (recorded in the coverage database 240). The model may optimize its performance by iteratively reducing this difference, such as through the use of a loss function.

After the correlation analysis, a ranking list 320 is generated for each desired coverage event (or state). The ranking list 320 prioritizes the test components according to their influence on triggering the corresponding coverage event. Test components that are consistently present in successful hits (e.g., Test Component A) may be ranked higher in the list.

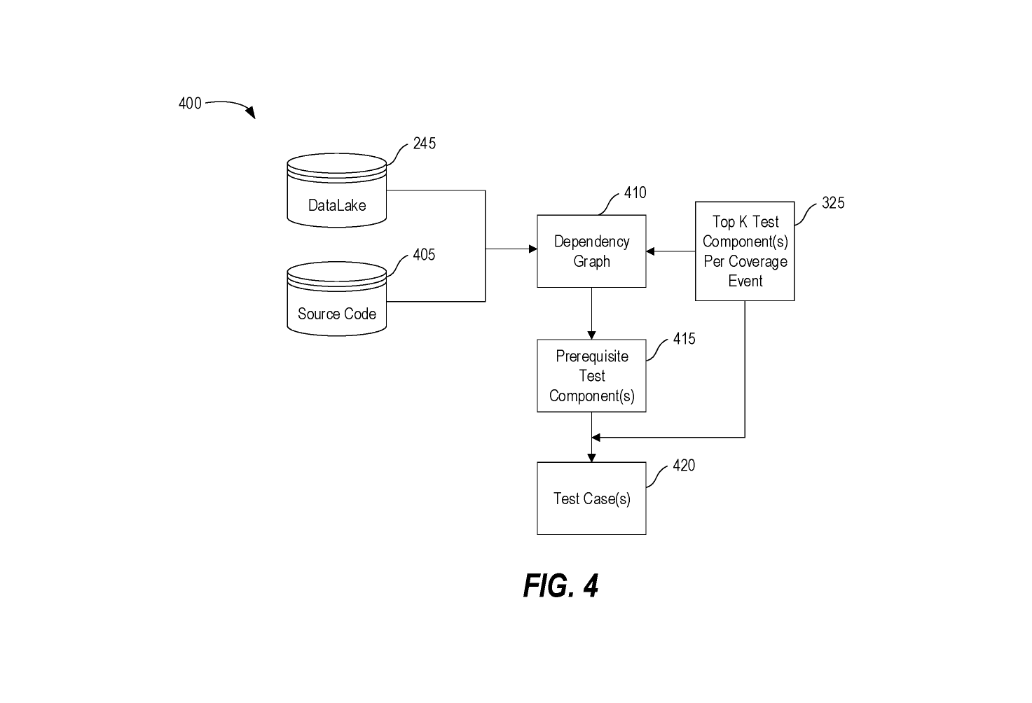

Based on the ranking list, a certain number of top-ranked test components 325 may be selected to guide further test case generations. For example, in embodiments of the “instruction storage interrupt” coverage event, the ranking list 320 may show that Test Component A (long-latency floating point instructions) is most strongly associated with triggering the event, ranking first, followed by Test Component C (store instructions), Test Component B (branch instructions), and additional components like Test Components D and E. The system may select Test Component A for generating further targeted test cases, to improve the likelihood of hitting the “instruction storage interrupt” state. More details regarding the test case generation process are discussed below with reference to FIG. 4.

In some embodiments, the number of top-ranked test components selected for further test case generation (including the possibility of selecting one) may vary, depending on factors such as the complexity of the overage event, the available test resources, or the specific verification goals.

FIG. 4 depicts an example architecture 400 for test case generation, according to some embodiments of the present disclosure.

As depicted, the source code 405 of the DUV (e.g., 210 of FIG. 2) and the data stored in the datalake 245 (e.g., data from hit cases) are analyzed to generate a dependency graph 410. In some embodiments, the datalake 245 may provide historical information from prior tests, including which test components were executed to hit specific coverage events. The source code 405 contains all the instructions and operations that are built into the DUV 210 and can be executed during testing. Additionally, in some embodiments, the source code 405 may reveal the logical flow of the DUV, showing how different test components interact. For example, the source code 405 may disclose that certain memory access instructions (e.g., load instructions or add instructions) require specific register or memory states to be set up, and certain branch instructions require specific conditions to be met.

By analyzing both sources, the dependency relationships between various test components are determined, and a corresponding dependency graph 410 reflecting these dependencies is generated. For example, the dependency graph may show that, before executing Test Component A (long-latency floating point instructions), the system needs to perform Test Component B (branch instructions) to set up the necessary control flow.

When a top-ranked test component 325 is selected from the ranking list 320, the system consults the dependency graph 410 to determine if there are any prerequisite test components 415 that must be executed before or in conjunction with the selected component. In the above example where the “instruction storage interrupt” event is targeted, if Test Component A is selected, the system may determine that Test Component B must be executed before Test Component A.

Once the prerequisites 415 are identified, the system generates a test sequence by incorporating both the prerequisite test components 415 and the selected top-ranked test component 325. The test sequence is configured to ensure that the dependencies between components are properly handled, which therefore maximizes (or at least increases) the likelihood of hitting the coverage event. In the above example, the test sequence may involve executing Test Component B, followed by Test Component A to respect the dependency relationship and increase the chances of trigging the “instruction storage interrupt” event.

After the test sequence is generated, the system creates the final test cases 420. In some embodiments, the test cases 420 may include the selected test component (e.g., Test Component A) and any prerequisite components (e.g., Test Component B), following the defined test sequence. In some embodiments, random instructions or operations may be added to the test cases 420 to simulate realistic test scenarios or conditions.

In some embodiments, the test generation process may be repeated for each selected test component 325. For example, after generating one or more test cases involving Test Component A, the system may proceed to create additional test cases for other top-ranked components, such as Test Component B or C. In some embodiments, the system may be configured to set a predefined limit on the number of test cases. When the number of generated test cases meets or exceeds this specific limit, the automated process ends with no further test cases being generated.

In some embodiments, once the test generation process is complete, the newly generated test cases may be applied to the DUV (e.g., 210 of FIG. 2). The system may monitor the results by tracking whether the new test cases successfully trigger the target coverage events and collecting data on the DUV’s response for further analysis.

Since the newly generated test cases are built around top-ranked test components that have been identified as strongly correlated with hitting the target coverage event (e.g., the “instruction storage interrupt” event), these test cases are more likely to produce successful outcomes compared to general or random test cases. By focusing on these top-ranked components (e.g., Test Component A, B, or C), these test cases maximize (or at least increase) the chances of hitting the target coverage event. Additionally, the inclusion of prerequisite components further increases the likelihood of reaching the target coverage event, as it provides all necessary conditions in place for the selected test component to operate as intended.

The disclosed automated test generation mechanism reduces the number of redundant or ineffective test cases. Therefore, the disclosed mechanism saves valuable testing time and resources, and improves the overall testing efficiency.

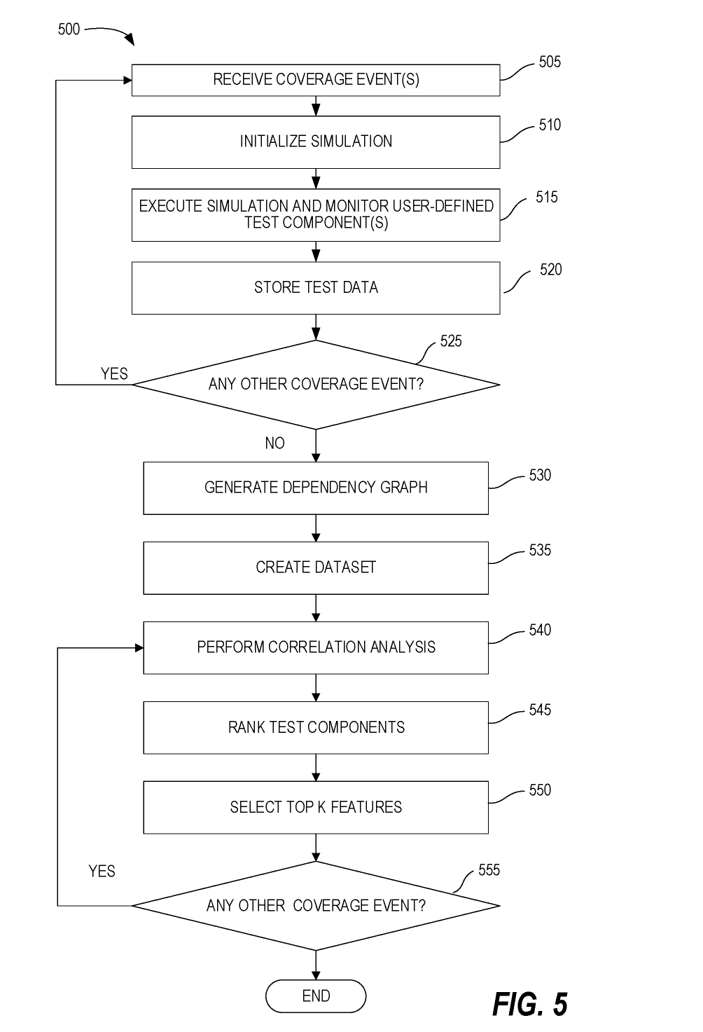

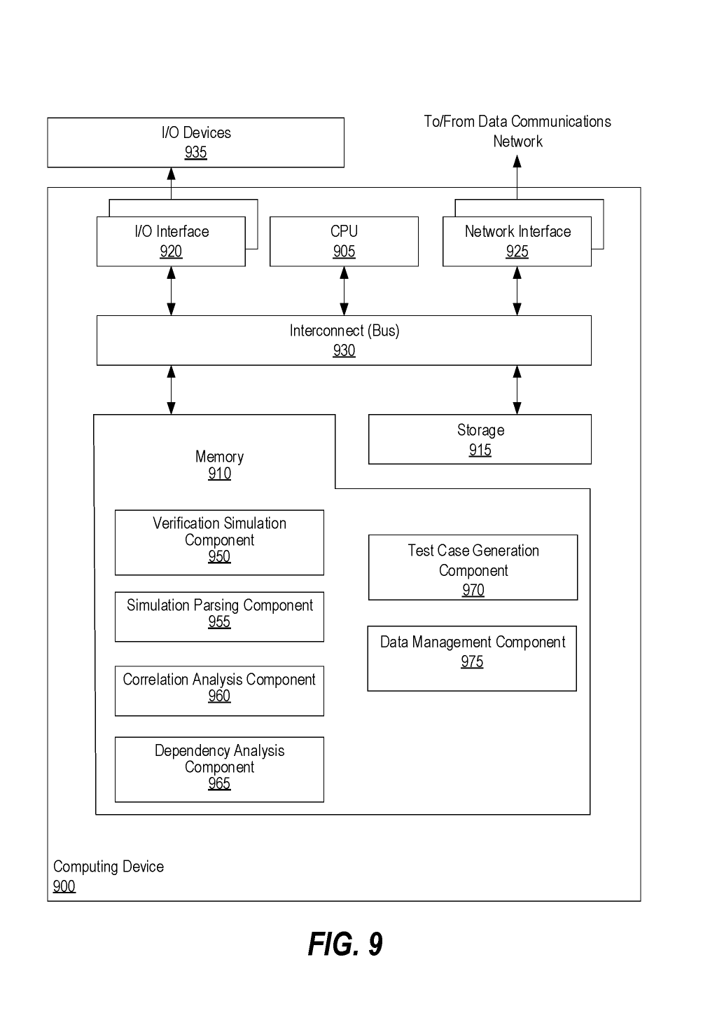

FIG. 5 depicts an example method 500 for generating dependency graphs and identifying top-ranked test components, according to some embodiments of the present disclosure. In some embodiments, the method 500 may be performed by one or more computing devices or systems, such as the computer 101 as illustrated in FIG. 1, or the computing device 900 as illustrated in FIG. 9.

At block 505, a computing system (e.g., 101 of FIG. 1) receives one or more user-defined coverage events (e.g., the event of “instruction storage interrupt”). In some embodiments, the user-defined coverage events may include states or behaviors that are not easily triggered (or reached) by running randomly generated test cases. These events may require more targeted test cases to ensure adequate coverage.

At block 510, the computing system initializes the test environment and prepares the DUV (e.g., 210 of FIG. 2) for simulation.

At block 515, the computing system runs the simulation. For each received coverage event, one or more user-defined test components (e.g., Test Components A, B, and C) may be defined. In some embodiments, the user-defined test components may include instructions or operations that the tester believes are most likely to trigger the specific coverage event. During the simulation, the computing system may run some general tests and observe whether (i) the user-defined test components (e.g., Test Components A, B, or C) are executed and successfully hit the coverage event, or (ii) the coverage event is hit independently, through the execution of other test components (e.g., Test Components D or E).

If either of the situations is met, at block 520, the computing system saves the relevant test data, including the executed test components, in a database, which is then stored in the datalake (e.g., 245 of FIG. 2) for further analysis. Additionally, in some embodiments, coverage data for these general (or randomly generated) tests (whether the event was hit or missed) may be collected and saved in the coverage database (e.g., 240 of FIG. 2) for further analysis.

At block 525, the computing system checks if any of the received coverage events remain untested. If any events are still untested, the method 500 returns to block 515 to continue running the simulation. If all coverage events have been tested and relevant test data has been recorded, the method 500 proceeds to block 530.

At block 530, the computing system analyzes the source code (which includes logical structure defined in the DUV) (e.g., 405 of FIG. 4) and the information in the datalake (e.g., 245 of FIG. 2) to create a dependency graph. In some embodiments, the dependency graph (e.g., 410 of FIG. 4) may represent the dependencies and relationships between various test components, such as how certain test components depend on others. For example, the dependency graph may show that Test Component B (branch instructions) is a prerequisite for Test Component A (long-latency floating point instructions), and certain register setup instructions must be performed before executing Test Component A.

At block 535, the computing system creates a dataset that links the test components executed when a specific coverage event was reached to the overall coverage outcomes. In some embodiments, the creation of the dataset may be performed by joining the data from the coverage database (e.g., 240 of FIG. 2) (which tracks all test outcomes, including hits and misses) with the datalake (e.g., 245 of FIG. 2) (which contains detailed information on the test components involved in the hit cases). In some embodiments, the test components may be saved as features in the dataset, and the coverage outcomes (hit or miss) may be saved as output variables.

At block 540, the computing system performs correlation analysis on the generated dataset to identify how closely each test component is associated with successfully triggering a specific coverage event. In some embodiments, statistical models or ML models may be applied to analyze the dataset and estimate the correlation between the test components (e.g., Test Components A-E) and the hit of a received event (e.g., the “instruction storage interrupt” event).

At block 545, based on the correlation analysis, the computing system ranks the test components for each average event according to their likelihood to hit the target state.

At block 550, the computing system selects a certain number of top-ranked test components (including one) for each coverage event based on the correlation analysis performed at block 545. These top-ranked components may guide the generation of more targeted test cases.

At block 555, the computing system determines whether there are any coverage events from the received list for which correlation analysis has not been performed. If there are unprocessed events, the method 500 returns to block 540, where the computing system repeats the correlation analysis for the next event. If all received coverage events have been analyzed and processed, the method 500 ends.

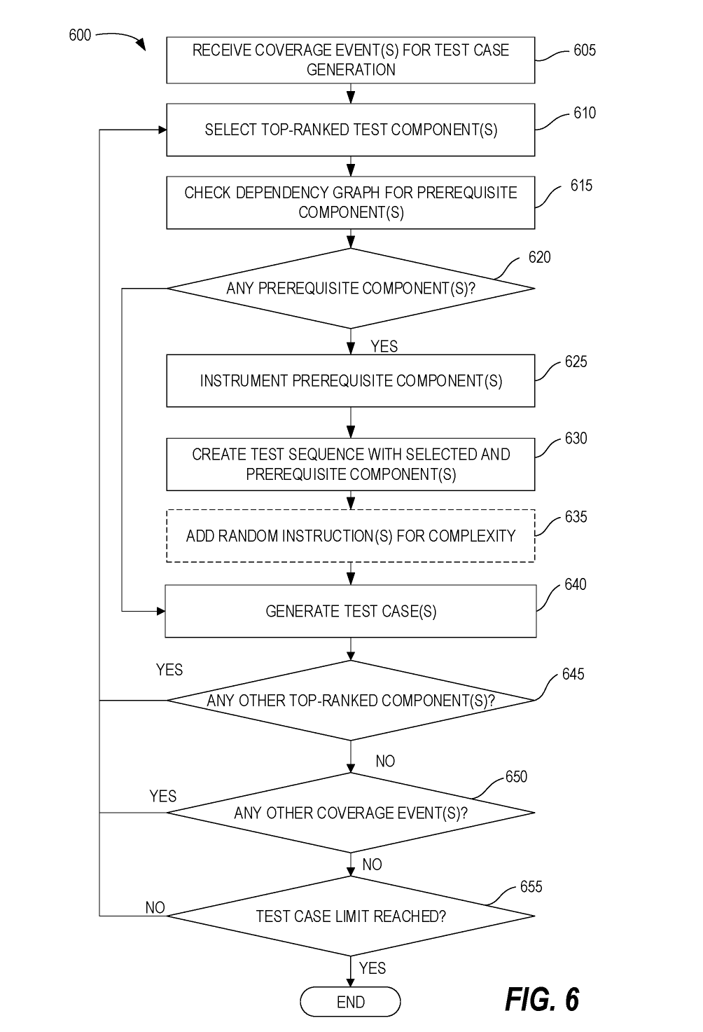

FIG. 6 depicts an example method 600 for generating test cases based on top-ranked features, according to some embodiments of the present disclosure. In some embodiments, the method 500 may be performed by one or more computing devices or systems, such as the computer 101 as illustrated in FIG. 1, or the computing device 900 as illustrated in FIG. 9.

At block 605, a computing system (e.g., 101 of FIG. 1) receives one or more user-defined coverage events. In some embodiments, these coverage events may be hard to trigger (or be reached) during regular simulation, and therefore require more focused and targeted test cases to maintain desired coverage.

At block 610, the computing system selects a top-ranked test component from the ranking list that is generated for a coverage event (e.g., 320 of FIG. 3). As discussed above, the test components (e.g., Test Components A-E) for the coverage event (e.g., the “instruction storage interrupt” event) are ranked based on how frequently and effectively each component has contributed to hitting the event in prior test cases.

At block 615, the computing system checks the dependency graph (e.g., 410 of FIG. 4) to determine if the selected test component relies on any prerequisite components for proper execution. If prerequisites are identified, the method 600 proceeds to block 625. If no prerequisite is identified, the method 600 moves directly to block 640, where the computing system generates the test case containing the selected components and random instructions (if any), and stores the test cases for simulation.

At block 625, the computing system includes the prerequisite test components (e.g., Test Component B or macro for CPU register setup) in the test case to ensure proper setup for the selected test component (e.g., Test Component A).

At block 630, the computing system generates a test sequence. In some embodiments, the test sequence may organize the prerequisite components (e.g., Test Component B or macro for CPU register setup) followed by the selected test component (e.g., Test Component A) to increase the chance of hitting the coverage event.

At block 635, the computing system may optionally insert random instructions into the test sequence to simulate a realistic test environment.

At block 640, the computing system generates the final test cases that contain the selected test components, the identified prerequisites, and random instructions (if any). The computing system then saves the test cases for simulation.

At block 645, the computing system checks if other top-ranked components have been selected for the same coverage event for generating new test cases. If yes, the method 600 returns to block 610 to select the next component and repeat the test case generation process.

At block 650, the computing system determines if there are any coverage events from the received list that require generating new test cases. If yes, the method 600 returns to block 610, where the computing system handles the next event and repeats the test case generation process.

At block 655, the computing system determines if the test case limit has been reached. If no, the method 600 returns to block 610, where the computing system continues to generate new test cases. If yes, the method 600 ends.

In some embodiments, the computing system may further refine the selection by choosing a subset of these generated test cases based on one or more policy recommendations or user-defined preferences. These policies or preferences may be based on factors such as test coverage goals, resource constraints, time limits, or specific verification objectives. For example, the system may prioritize test cases for a coverage event with historically low coverage (compared with others in the received list), and/or select test cases that meet specific timing or performance benchmarks. The refinements may optimize resource usage and make the testing process more closely align with broader verification strategies.

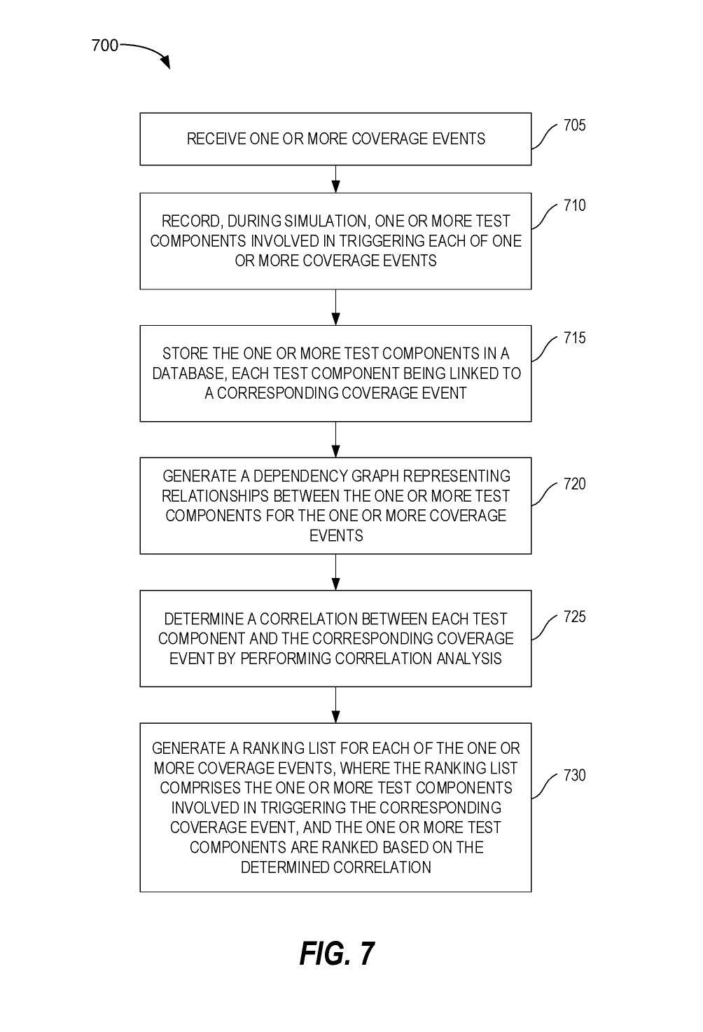

FIG. 7 is a flow diagram depicting an example method 700 for data collection and correlation analysis, according to some embodiments of the present disclosure.

At block 705, a computing system (e.g., 101 of FIG. 1) receives one or more coverage events.

At block 710, the computing system records, during simulation, one or more test components involved in triggering each of one or more coverage events.

At block 715, the computing system stores the one or more test components in a database (e.g., 245 of FIG. 2), each test component being linked to a corresponding coverage event.

At block 720, the computing system generates a dependency graph (e.g., 410 of FIG. 4) representing relationships between the one or more test components for the one or more coverage events.

At block 725, the computing system determines a correlation between each test component and the corresponding coverage event by performing correlation analysis.

At block 730, the computing system generates a ranking list (e.g., 320 of FIG. 3) for each of one or more coverage events, where the ranking list comprises the one or more test components involved in triggering the corresponding coverage event, and the one or more test components are ranked based on the determined correlation.

In some embodiments, the test components may be selected from the group consisting of macros, instructions, and instruction categories.

In some embodiments, to determine the correlation between each test component and the corresponding coverage event by performing correlation analysis, the computing system may create a dataset by joining the database with a coverage database, and execute a score-based model on the dataset to determine a correlation between each test component and the corresponding coverage event.

In some embodiments, to determine the correlation between each test component and the corresponding coverage event by performing correlation analysis, the computing system may create a dataset by joining the database with a coverage database, and execute a machine learning (ML) model on the dataset to determine a correlation between each test component and the corresponding coverage event.

In some embodiments, to determine the correlation between each test component and the corresponding coverage event by performing correlation analysis, the computing system may train the ML model to predict correlations based on a training dataset and a selected ML algorithm.

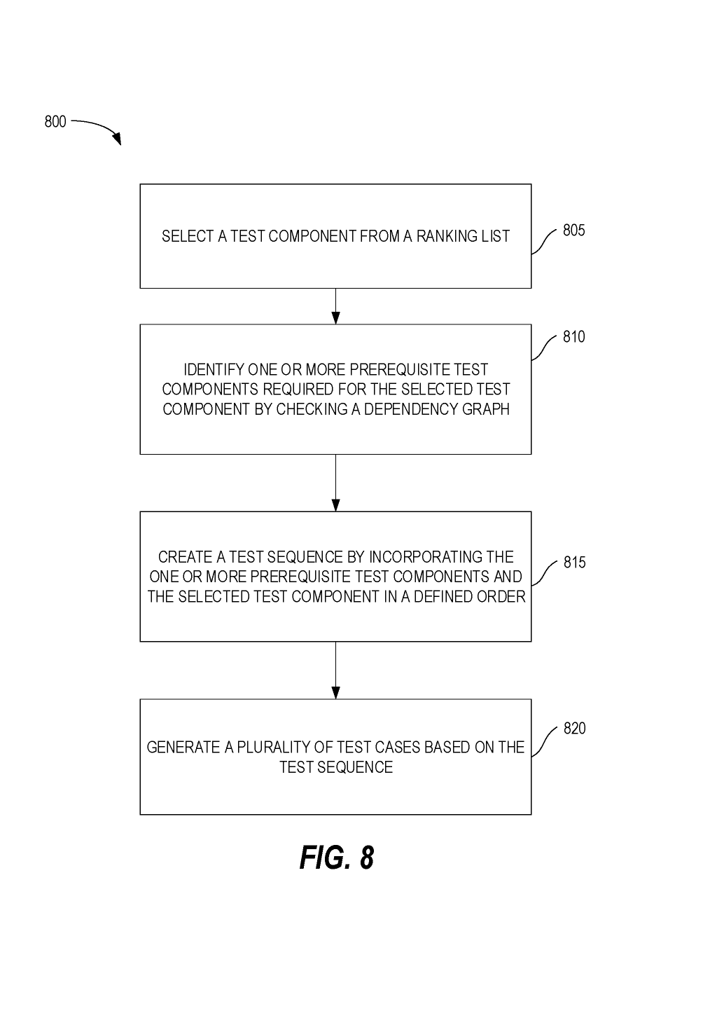

FIG. 8 is a flow diagram depicting an example method 800 for automated test generation, according to some embodiments of the present disclosure.

At block 805, a computing system (e.g., 101 of FIG. 1) selects a test component (e.g., 325 of FIG. 4) from a ranking list (e.g., 320 of FIG. 3).

At block 810, the computing system identifies one or more prerequisite test components (e.g., 415 of FIG. 4) required for the selected test component by checking a dependency graph (e.g., 410 of FIG. 4).

At block 815, the computing system creates a test sequence by incorporating the one or more prerequisite test components and the selected test component in a defined order.

At block 820, the computing system generates a plurality of test cases (e.g., 420 of FIG. 4) based on the test sequence. In some embodiments, to generate the plurality of test cases, the computing system may insert one or more random instructions around the test sequence to simulate realistic testing scenarios.

In some embodiments, the computing system may select a set of test cases from the plurality of test cases based on one or more policy preferences.

FIG. 9 depicts an example computing device 900 configured to perform various aspects of the present disclosure, according to some embodiments of the present disclosure. Although depicted as a physical device, in some embodiments, the computing device 900 may be implemented using virtual device(s), and/or across a number of devices (e.g., in a cloud environment).

As illustrated, the computing device 900 includes a CPU 905, memory 910, storage 915, one or more network interfaces 925, and one or more I/O interfaces 920. In the illustrated embodiment, the CPU 905 retrieves and executes programming instructions stored in memory 910, as well as stores and retrieves application data residing in storage 915. The CPU 905 is generally representative of a single CPU and/or GPU, multiple CPUs and/or GPUs, a single CPU and/or GPU having multiple processing cores, and the like. The memory 910 is generally considered to be representative of a random access memory. Storage 915 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 935 (such as keyboards, monitors, etc.) are connected via the I/O interface(s) 920. Further, via the network interface 925, the computing device 900 can be communicatively coupled with one or more other devices and components (e.g., via a network, which may include the Internet, local network(s), and the like). As illustrated, the CPU 905, memory 910, storage 915, network interface(s) 925, and I/O interface(s) 920 are communicatively coupled by one or more buses 930.

In the illustrated embodiment, the memory 910 includes a verification simulation component 950, a simulation parsing component 955, a correlation analysis component 960, a dependency analysis component 965, a test case generation component 970, and a data management component 975. Although depicted as discrete components for conceptual clarity, in some embodiments, the operations of the depicted components (and others not illustrated) may be combined or distributed across any number of components. Further, although depicted as software residing in memory 910, in some embodiments, the operations of the depicted components (and others not illustrated) may be implemented using hardware, software, or a combination of hardware and software.

In one embodiment, the verification simulation component 950 may combine the functions of stimulus generator (e.g., 205 of FIG. 2) and driver/monitor (e.g., 215 of FIG. 2). The verification simulation component 950 may generate test stimuli and apply them to the DUV (e.g., 210 of FIG. 2), which is the system being tested. As the DVU processes these stimuli, the verification simulation component 950 may also monitor the DUV’s execution, and capture data such as executed instructions, state changes, and overage event triggers. The generated stimuli may be saved as stimulus artifacts (e.g., 220 of FIG. 2), and the captured response data may be saved as driver/monitor artifacts (e.g., 225 of FIG. 2).

In one embodiment, the simulation parsing component 955 may process the stimulus and driver/monitor artifacts to filter the data. The simulation parsing component 955 may determine whether the coverage events have been hit, which test components were executed, and whether any predefined test components contributed to hitting the coverage event, and save the relevant data to a database (e.g., 245 of FIG. 2).

In one embodiment, the correlation analysis component 960 may perform correlation analysis on the parsed data to identify the relationship between test components and the likelihood of triggering coverage events. The correlation analysis component 960 may use statistical models or ML algorithms to rank test components based on the determined correlation.

In one embodiment, the dependency analysis component 965 may analyze the source code of the DUV (e.g., 405 of FIG. 4) and the parsed data to generate a dependency graph. The graph may specify the relationships between test components, showing which components depend on others and whether any prerequisites must be executed in a specific order.

In one embodiment, the test case generation component 970 may generate targeted test cases by selecting test components (from the ranking list) and determining their prerequisites. In some embodiments, the test case generation component 970 may add random instructions to simulate more realistic testing scenarios.

In one embodiment, the data management component 975 may handle the datalake where stimuli, test cases, and test component data are stored. The data management component 975 may also manage the coverage database, which records the outcomes of the tests, including hit or miss information for the coverage events.

In the illustrated example, the storage 915 may include a variety of data for effective operation of the computing device for automated test case generation. The data may include, but is not limited to, test stimulus artifacts (which store information about the random or targeted inputs applied to the DUV), driver/monitor artifacts (which capture the DUV’s responses like executed instructions, state changes, and triggered coverage events), dependency graphs, ranking lists for each coverage event, and test cases generated by the system for future simulation. In some embodiments, the aforementioned data may be saved in a remote database that connects to the computing device 900 via a network (e.g., the Internet).

While the foregoing is directed to embodiments of the present invention, other and further embodiments of the invention may be devised without departing from the basic scope thereof, and the scope thereof is determined by the claims that follow.

What is claimed is:

1. A computer-implemented method, comprising
receiving one or more coverage events;
recording, during simulation, one or more test components involved in triggering each of one or more coverage events;
storing the one or more test components in a database, each test component being linked to a corresponding coverage event;
generating a dependency graph representing relationships between the one or more test components for the one or more coverage events;
determining a correlation between each test component and the corresponding coverage event by performing correlation analysis; and
generating a ranking list for each of the one or more coverage events, wherein the ranking list comprises the one or more test components involved in triggering the corresponding coverage event, and the one or more test components are ranked based on the determined correlation.

2. The computer-implemented method of claim 1, further comprising:
selecting a test component from the ranking list;
identifying one or more prerequisite test components required for the selected test component by checking the dependency graph;
creating a test sequence by incorporating the one or more prerequisite test components and the selected test component in a defined order; and
generating a plurality of test cases based on the test sequence.

3. The computer-implemented method of claim 1, wherein the test components are selected from the group consisting of macros, instructions, and instruction categories.

4. The computer-implemented method of claim 1, wherein determining the correlation between each test component and the corresponding coverage event by performing correlation analysis comprises:
creating a dataset by joining the database with a coverage database; and
executing a score-based model on the dataset to determine a correlation between each test component and the corresponding coverage event.

5. The computer-implemented method of claim 1, wherein determining the correlation between each test component and the corresponding coverage event by performing correlation analysis comprises:
creating a dataset by joining the database with a coverage database; and
executing a machine learning (ML) model on the dataset to determine a correlation between each test component and the corresponding coverage event.

6. The computer-implemented method of claim 5, wherein determining the correlation between each test component and the corresponding coverage event by performing correlation analysis further comprises training the ML model to predict correlations based on a training dataset and a selected ML algorithm.

7. The computer-implemented method of claim 2, further comprising selecting a set of test cases from the plurality of test cases based on one or more policy preferences.

8. The computer-implemented method of claim 2, wherein generating the plurality of test cases based on the test sequence comprises inserting one or more random instructions around the test sequence to simulate realistic testing scenarios.

9. A system, comprising:
one or more memories collectively containing one or more programs;
one or more processors, wherein the one or more processors are configured to, individually or collectively, perform an operation comprising:
receiving one or more coverage events;
recording, during simulation, one or more test components involved in triggering each of one or more coverage events;
storing the one or more test components in a database, each test component being linked to a corresponding coverage event;
generating a dependency graph representing relationships between the one or more test components for the one or more coverage events;
determining a correlation between each test component and the corresponding coverage event by performing correlation analysis; and
generating a ranking list for each of one or more coverage events, wherein the ranking list comprises the one or more test components involved in triggering the corresponding coverage event, and the one or more test components are ranked based on the determined correlation.

10. The system of claim 9, wherein the one or more processors are configured to, individually or collectively, perform the operation further comprising:
selecting a test component from the ranking list;
identifying one or more prerequisite test components required for the selected test component by checking the dependency graph;
creating a test sequence by incorporating the one or more prerequisite test components and the selected test component in a defined order; and
generating a plurality of test cases based on the test sequence.

11. The system of claim 9, wherein the test components are selected from the group consisting of macros, instructions, and instruction categories.

12. The system of claim 9, wherein determining the correlation between each test component and the corresponding coverage event by performing correlation analysis comprises:
creating a dataset by joining the database with a coverage database; and
executing a score-based model on the dataset to determine a correlation between each test component and the corresponding coverage event.

13. The system of claim 9, wherein determining the correlation between each test component and the corresponding coverage event by performing correlation analysis comprises:
creating a dataset by joining the database with a coverage database; and
executing a machine learning (ML) model on the dataset to determine a correlation between each test component and the corresponding coverage event.

14. The system of claim 13, wherein determining the correlation between each test component and the corresponding coverage event by performing correlation analysis further comprises training the ML model to predict correlations based on a training dataset and a selected ML algorithm.

15. The system of claim 10, wherein the one or more processors are configured to, individually or collectively, perform the operation further comprising selecting a set of test cases from the plurality of test cases based on one or more policy preferences.

16. The system of claim 10, wherein generating the plurality of test cases based on the test sequence comprises inserting one or more random instructions around the test sequence to simulate realistic testing scenarios.

17. One or more computer-readable media containing, in any combination, computer program code that, when executed by operation of a computer system, performs an operation comprising:
receiving one or more coverage events;
recording, during simulation, one or more test components involved in triggering each of one or more coverage events;
storing the one or more test components in a database, each test component being linked to a corresponding coverage event;
generating a dependency graph representing relationships between the one or more test components for the one or more coverage events;
determining a correlation between each test component and the corresponding coverage event by performing correlation analysis; and
generating a ranking list for each of one or more coverage events, wherein the ranking list comprises the one or more test components involved in triggering the corresponding coverage event, and the one or more test components are ranked based on the determined correlation.

18. The one or more computer-readable media of claim 17, wherein the computer program code that, when executed by operation of a computer system, performs the operation further comprising:
selecting a test component from the ranking list;
identifying one or more prerequisite test components required for the selected test component by checking the dependency graph;
creating a test sequence by incorporating the one or more prerequisite test components and the selected test component in a defined order; and
generating a plurality of test cases based on the test sequence.

19. The one or more computer-readable media of claim 17, wherein determining the correlation between each test component and the corresponding coverage event by performing correlation analysis comprises:
creating a dataset by joining the database with a coverage database; and
executing a score-based model on the dataset to determine a correlation between each test component and the corresponding coverage event.

20. The one or more computer-readable media of claim 18, wherein the computer program code that, when executed by operation of a computer system, performs the operation further comprising selecting a set of test cases from the plurality of test cases based on one or more policy preferences.
